(19) United States
(12) Patent Application Publication
(10) Pub. No.: US 2025/0050772 A1
(43) Pub. Date: Feb. 13, 2025

(54) INTEGRATED SYSTEM FOR CHARGING ELECTRIC VEHICLES AND HYDROGEN VEHICLES

(71) Applicant: Nuovo Pignone Tecnologie - S.r.l., Florence (IT)

(72) Inventors: Maneesh PANDEY, Hyderabad (IN); Manjush GANIGER, Belgaum (IN); Rahul WAGH, Bangalore (IN); Rakesh GOVINDASAMU, Tamil Nadu State (IN)

(21) Appl. No.: 18/722,952

(22) PCT Filed: Dec. 21, 2022
(86) PCT No.: PCT/EP2022/025586

§ 371 Date: Jun. 21, 2024

(30) Foreign Application Priority Data
Dec. 23, 2021 (IT) 102021000032474

(51) Int. Cl. B60L 53/53; B60L 53/302; B60S 5/02; C25B 9/65; C25B 15/08; H01M 8/04082; H01M 8/0656; H01M 10/44

(52) U.S. Cl. CPC B60L 53/53; B60L 53/302; B60S 5/02; C25B 9/65; C25B 15/08; H01M 8/04201; H01M 8/0656; H01M 10/44; H01M 2220/20; H01M 2250/20

(57) ABSTRACT

A vehicle charging system comprising a gas turbine engine mechanically coupled to an electric generator to produce electrical energy, the electrical energy is split into a first electrical energy and a second electrical energy by a power splitter, the first electrical energy is used for charging electric vehicles and the second electrical energy is used for charging hydrogen vehicles for example through an electrolyzer.

### TECHNICAL FIELD

The subject-matter disclosed herein relates to a vehicle charging system for charging electric vehicles and hydrogen vehicles.

### BACKGROUND ART

For a more sustainable future, a transition from internal combustion engines (ICEs) to green mobility is the key. Therefore, industry players are focusing on automotive technology innovation, mainly developing hydrogen-powered mobility and electric-powered mobility.

However, also in order to build more confidence on energy transition, availability of a charging infrastructure and efficient charging stations play an important role in the transformation of the mobility industry. Some of the biggest challenges are for example the provision of a charging infrastructure at remote locations and the capacity of the electric grid infrastructure to support varying charging loads, which depends on the number of vehicles being charged.

From the patent document published as US20200156487A1 there is known a system and a method for charging electric vehicles using a steam turbine to generate electrical energy. The system is coupled to the electric grid. According to this document, the electrical energy generated by the steam turbine can be stored in a storage unit and can be supplied to the electric grid in order to help meet peak energy demands (e.g., when a rate of consumption exceeds the rate of electricity generation). Moreover, generated electrical energy may be “stored” in the batteries of an electric vehicle when the batteries are charged, and then, later, the vehicle batteries may be utilized in a “vehicle-to-grid” system whereby the electrical energy in the vehicle batteries is supplied to the electric grid.

However, it is desirable to have a charging system to flexibly charge either electric vehicles or hydrogen vehicles, even simultaneously, at any location, without the need of an electric grid infrastructure.

### SUMMARY

According to an aspect, the subject-matter disclosed herein relates to a vehicle charging system which comprising a gas turbine engine mechanically coupled to an electric generator to produce electrical energy; the electrical energy is split into a first electrical energy and a second electrical energy by a power splitter; the first electrical energy is used for charging electric vehicles and the second electrical energy is used for charging hydrogen vehicles in particular through an electrolyzer.

In particular, the subject-matter disclosed herein relates to a vehicle charging system which is “carbon neutral”, i.e. that does not inject (substantial amount of) carbon (for example in the form of carbon dioxide) into the atmosphere. This is achieved by providing the system with a carbon capture unit configured to receive the exhaust gases discharged by the gas turbine engine and capture the carbon dioxide present therein, in order to release carbon dioxide-free gases into the atmosphere.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a simplified diagram of an embodiment of an integrated system for charging electric vehicles and hydrogen vehicles, and

FIG. 2 shows a more detailed diagram of the embodiment of FIG. 1.

### DETAILED DESCRIPTION OF EMBODIMENTS

According to an aspect, the subject-matter disclosed herein relates to a vehicle charging system, which can be installed at a vehicle recharging station, that can recharge both electric vehicles and hydrogen vehicles without the need of external electrical energy supply and with a reduced environmental impact. The vehicle charging system has a gas turbine engine to produce electrical energy, which is preferably constant in time and resulting from the operation of the turbine at nominal power. The electrical energy is then appropriately (typically variably) split between a first part of the system dedicated to electric vehicle charging and a second part of the system dedicated to hydrogen vehicle charging. The electrical energy may be supplied to an electric storage unit and then to an external electric vehicle which is connected to a socket outlet of the electric vehicle charging station, and/or to an electrolyzer to produce hydrogen which is supplied to a hydrogen storage unit and then to an external hydrogen vehicle which is connected to a hydrogen dispenser of the hydrogen vehicle charging station. A small and constant (i.e. not particularly fluctuating) amount of the electrical energy may be also supplied to the auxiliaries of the system, for example compressors or pumps or motors.

Advantageously, the vehicle charging system is also provided with a carbon capture unit configured to receive the exhaust gases discharged by the gas turbine engine and capture the carbon dioxide present therein. Advantageously, the vehicle charging system is also provided with a waste heat recovery unit upstream the carbon capture unit which is configured to transfer part of the heat of exhaust gases from the gas turbine engine, to a demineralized water flow to be sent to the electrolyzer, in order to increase the efficiency of the electrolyzation.

Reference now will be made in detail to embodiments of the disclosure, an example of which is illustrated in the drawings. Each embodiment is provided by way of explanation of the disclosure, not limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

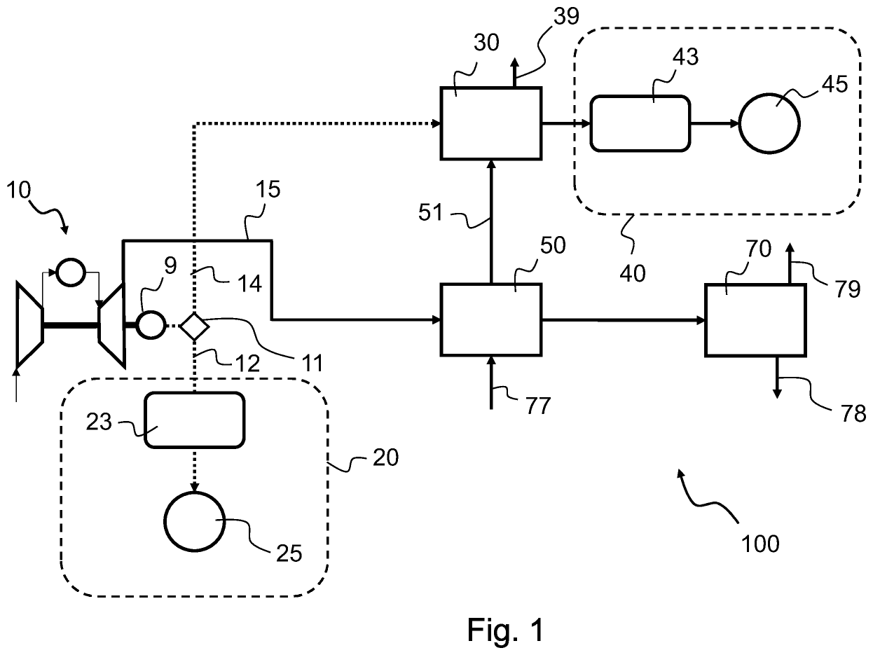

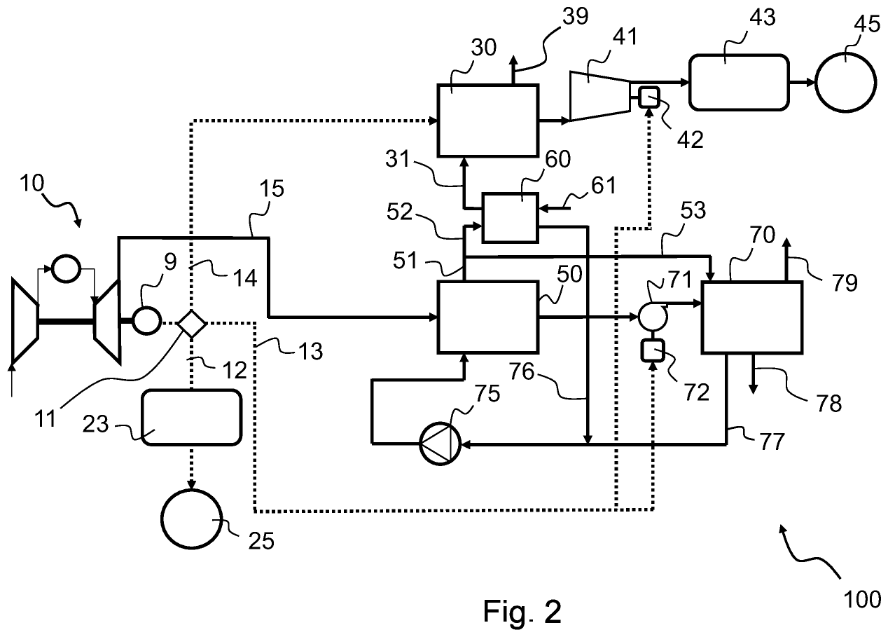

FIGS. 1 and 2 schematically show an embodiment of an innovative integrated system for charging electric vehicles and hydrogen vehicles. The vehicle charging system is generally indicated with reference numeral 100. As it will be clear, FIG. 1 and FIG. 2 correspond to each other and (partially) show the same components as vehicle charging system 100: FIG. 1 shows a simplified diagram of the vehicle charging system 100, wherein only the principal flows of electrical energy and fluids are highlighted, while other flows are not shown (only for the sake of clarity) while FIG. 2 shows a more detailed diagram of the vehicle charging system 100. It is to be noted that in FIGS. 1 and 2 the electrical energy flows are represented by a dotted line and the fluid flows are represented by a solid line.

The vehicle charging system 100 comprises a gas turbine engine 10 which typically comprises a compressor section 1, a combustor section 2 and an expander section 3. The compressor section 1 is configured to suck inlet air from the surrounding ambient air (see the small arrow entering the compressor section 1) and to generate a compressed air flow at an outlet of the compressor section 1 (see the small arrow exiting the compressor section 1). The combustor section 2 is configured to receive the compressed air flow from the compressor section 1 and a fuel from an external supply and perform a combustion. The expander section 3 is configured to receive burned gases from the combustor section 2, as shown in FIGS. 1 and 2 by the thin arrow which connects the combustor section 2 and the expander section 3, and perform an expansion of burned gases, producing exhaust gases at an outlet of the expander section 3 transforming thus thermal energy to mechanical energy (expander rotation).

The vehicle charging system 100 comprises further an electric generator 9 which is mechanically coupled to the gas turbine engine 10, in particular by means of a shaft that is coupled to the expander section 3, and is configured to transform mechanical energy to electrical energy, generating an output of electrical energy. In particular, the gas turbine engine 10 is configured to operate always at nominal power (i.e. the power generated by the gas turbine engine 10 is the same produced in normal operating conditions).

The vehicle charging system 100 comprises further a power splitter 11 which is electrically coupled to the electric generator 9 and is configured to receive electrical energy output therefrom (and eventually from other energy sources). The power splitter 11 is configured to split the electrical energy generated only from the electric generator 9. The power splitter 11 is configured to split the electrical energy at least into a first electrical energy 12 and a second electrical energy 14; preferably, the power splitter 11 is configured to split the electrical energy also in a third electrical energy 13 which is smaller than the first electrical energy 12 and the second electrical energy 14. For example, the power splitter 11 is configured to deliver mainly a first electrical energy 12, which is a portion of the electrical energy generated from the electric generator 9, to an electric vehicle charging station 20 till a certain threshold energy level is reached in an electric vehicle storage unit 23 configured to store electrical energy, then the power splitter 11 is configured to deliver mainly a second electrical energy 14, which is a portion of the electrical energy generated from the electric generator 9, to an hydrogen vehicle charging station 40; it is to be noted that the remaining portion(s) of the electrical energy generated from the electric generator 9 (i.e. not the main portions mentioned in the example above) are supplied to balance the system and/or to supply electrical energy to one or more auxiliary device. As it will be apparent from the following, the first electrical energy 12 and the second electrical energy 14 may vary over time (while the total electrical energy generated by the electric generator 9, i.e. the summary of the first electrical energy 12, the second electrical energy 14 and possibly the third electrical energy 13, remains constant over time) and are used respectively to charge (or to be more precise “recharge”) electric vehicles and hydrogen vehicles, in the following they will be called collectively “charging electrical energy”, while the third electrical energy 13 is substantially constant over time and is advantageously used to supply electrical energy to one or more auxiliary devices of the vehicle charging system which are electrically coupled to the power splitter 11; more advantageously, the third electrical energy 13 is used also to supply energy to auxiliary devices of the gas turbine engine 10. For example, if the total power output of the gas turbine engine 10 is 5.4 MW, the third electrical energy may be 0.6 MW while the first electrical energy and the second electrical energy may vary from 0 MW to 4.8 MW depending on the external loads, i.e. electric vehicle(s) and/or hydrogen vehicle(s), that are currently coupled at a certain time to the vehicle charging system 100 and/or according to a predetermined strategy, as it will be better explained below.

The vehicle charging system 100 comprises further an electric vehicle charging station 20 which is electrically coupled to the power splitter 11 and is configured to receive the first electrical energy 12 therefrom. The electric vehicle charging station 20 is also configured to be coupled to at least one electric vehicle and to supply electrical energy to the electric vehicle. Advantageously, the electric vehicle charging station 20 is provided with a port, in particular a socket outlet, into which an electric vehicle plug can be inserted for electric vehicle recharging.

Advantageously, the electric vehicle charging station 20 comprises an electric vehicle storage unit 23 configured to store electrical energy. With non-limiting reference to FIGS. 1 and 2, the electric vehicle storage unit 23 is electrically coupled to the power splitter 11 (see the dotted line connecting them) and is configured to receive the first electrical energy 12 therefrom. It is to be noted that the first electrical energy 12 may be intermittent so that the electric vehicle storage unit 23 may not be continuously supplied with electrical energy. Preferably, the electric vehicle storage unit 23 may be equipped with a sensor that measures the capacity level of the unit; even more advantageously, the electric vehicle storage unit 23 may be equipped with a sensor that may send a signal (for example an alarm or a warning) when the capacity level of the unit is equal for example to 90% of the maximum capacity of the electric vehicle storage unit 23 (for the sake of clarity we will refer to it as “high capacity signal”) and/or when the capacity level of the unit is equal for example to 10% of the maximum capacity of the electric vehicle storage unit 23 (for the sake of clarity we will refer to it as “low capacity signal”). Advantageously, according to any of the signals or preferably both signals, the power splitter 11 may vary the amount of the first electrical energy 12.

The vehicle charging system 100 comprises further an hydrogen generator that is electrically coupled to the power splitter 11 and is configured to generate hydrogen starting from one or more chemical substances and electricity; advantageously, the hydrogen generator is an electrolyzer 30 which is configured to perform electrolysis of water to generate hydrogen starting from water and electricity. With non-limiting reference to FIGS. 1 and 2, the electrolyzer 30 is electrically coupled to the power splitter 11 (see the dotted line connecting them) and is configured to receive the second electrical energy 14 therefrom. It is to be noted that the second electrical energy 14 may be intermittent so that the electrolyzer 30 may not be continuously supplied with electrical energy. As already mentioned, the electrolyzer 30 is configured to perform electrolysis: the electrolyzer 30 receives electrical energy in the form of the second electrical energy 14 and preferably a hot water or steam flow 51 as inputs and perform a chemical reaction which generates hydrogen and oxygen 39 as outputs. The oxygen 39 is typically discharged in the surrounding ambient or sent to a storage (see the small arrow departing from the electrolyzer 30), while the hydrogen is provided to a hydrogen vehicle charging station 40 (see the arrow departing from the electrolyzer 30 which enters the dotted area 40) to which the electrolyzer 30 is fluidly coupled. The hydrogen vehicle charging station 40 is configured to be coupled to at least one hydrogen vehicle and to supply hydrogen to the hydrogen vehicle. Advantageously, the hydrogen vehicle charging station 40 is provided with a hydrogen dispenser used to fill the vehicle tank with hydrogen.

Advantageously, the hydrogen vehicle charging station 40 comprises a hydrogen vehicle storage unit 43 configured to store hydrogen. With non-limiting reference to FIGS. 1 and 2, the hydrogen vehicle storage unit 43 is fluidly coupled to the electrolyzer and is configured to receive hydrogen therefrom. Preferably, the hydrogen vehicle storage unit 43 may be equipped with a sensor that measures the capacity level of the unit; even more advantageously, the hydrogen vehicle storage unit 43 may be equipped with a sensor that may send a signal (for example an alarm or a warning) when the capacity level of the unit is equal for example to 90% of the maximum capacity of the hydrogen vehicle storage unit 43 (for the sake of clarity we will refer to it as “high capacity signal”) and/or when the capacity level of the unit is equal for example to 10% of the maximum capacity of the hydrogen vehicle storage unit 43 (for the sake of clarity we will refer to it as “low capacity signal”). Advantageously, according to any of the signals or preferably both signals, the power splitter 11 may vary the amount of the second electrical energy 14.

Advantageously, the hydrogen vehicle charging station 40 comprises further at least a compressor 41 fluidly coupled to the electrolyzer 30. The compressor 41 is configured to receive hydrogen from the electrolyzer 30, compress hydrogen and provide compressed hydrogen to the hydrogen storage unit 43. It is to be noted that the compression of hydrogen may be divided into several stages by using a compressor 41 which has several stages, in order to increase compression efficiency. For example, the hydrogen may be produced by electrolyzer 30 at atmospheric pressure (typically about 1 bar) and be compressed by compressor 41 up to 350 bar using six stages of compression, each stage having a pressure ratio (i.e. the ratio between inlet pressure and outlet pressure) of about 2.66. Thanks to the compressor 41, it is possible to store compressed hydrogen in the hydrogen storage unit 43, which means substantially that the density of the hydrogen in the hydrogen storage unit 43 is increased.

Advantageously, the compressor 41 is mechanically coupled to a first electric motor 42 which is configured to convert electrical energy into mechanical energy to drive the compressor 41. Preferably, the first electric motor 41 is electrically coupled to the power splitter 11 11 (see the dotted line connecting them) and is configured to receive at least part of the third electrical energy 13 therefrom.

As already mentioned, the first electrical energy 12 and the second electrical energy 14 may vary over time in a range 0%-100% of the total power output of the gas turbine engine 10. Preferably, each of the first electrical energy 12 and the second electrical energy 14 may vary over time in a range 0%-100% of the total power output of the electric generator 9 minus the third electrical energy 13 (which is substantially constant over time), i.e. 0%-100% of the “charging electrical energy”. In particular, the first electrical energy 12 and the second electrical energy 14 may vary depending on the vehicles that are currently connected to the system (i.e. depending on the electrical energy and/or hydrogen required by vehicles and therefore “taken” from the electric vehicle charging station 20 and/or the hydrogen vehicle charging station 40) and/or may vary according to a predetermined strategy. It is to be noted that the predetermined strategy may also depend on one or more capacity signal of the electric vehicle storage unit 23 and/or the hydrogen vehicle storage unit 43.

According to a possibility, the power splitter 11 may vary the first electrical energy 12 and the second electrical energy 14 depending on the signal or signals received from sensors of the electric vehicle charging station 20 and/or the hydrogen vehicle charging station 40. For example, the first electrical energy 12 supplied by the power splitter 11 to the electric vehicle storage unit 23 may be e.g. 95% or 100% of the “charging electrical energy” when the sensor of the electric vehicle storage unit 23 sends a low capacity signal while the second electrical energy 14 supplied by the power splitter 11 to the electrolyzer 30 is e.g. 5% or 0% of the “charging electrical energy”. After a predetermined time, for example 5 minutes, after having received the signal, the power splitter 11 may vary the division of the electrical energy from the electric generator 9 so that the first electrical energy 12 is e.g. 70% or 80% of the “charging electrical energy” and the second electrical energy 14 is e.g. 30% or 20% of the “charging electrical energy”. After another predetermined time, for example 10 minutes, after having received the signal, the power splitter 11 may vary the division of the electrical energy from the electric generator 9 so that both the first electrical energy 12 and the second electrical energy 14 are e.g. 50% of the “charging electrical energy”.

According to another possibility, the first electrical energy 12 supplied by the power splitter 11 to the electric vehicle storage unit 23 may be e.g. 95% or 100% of the “charging electrical energy” when the sensor of the electric vehicle storage unit 23 sends a low capacity signal (while the second electrical energy 14 supplied by the power splitter 11 to the electrolyzer 30 is e.g. 5% or 0% of the “charging electrical energy”) and remains the same until sensor of the electric vehicle storage unit 23 sends a high capacity signal. At that time, the power splitter 11 may vary the division of the electrical energy from the electric generator 9 so that the first electrical energy 12 is e.g. 10% or 20% of the “charging electrical energy” and the second electrical energy 14 is e.g. 90% or 80% of the “charging electrical energy” and remains the same until another signal from the sensor of the electric vehicle storage unit 23 or the hydrogen vehicle storage unit 43 is sent. In fact, while the power splitter 11 is suppling electrical energy to the electric vehicle storage unit 23 and/or to the electrolyzer 30, the electric vehicle charging station 20 and/or hydrogen vehicle charging station 40 may be coupled to one or more vehicle which requires to be charged, hence consuming electrical energy from the electric vehicle storage unit 23 or hydrogen from the hydrogen vehicle storage unit 43 and therefore reducing the respective storage capacity.

According to another possibility, the first electrical energy 12 and the second electrical energy 14 may vary according to a predetermined schedule. In fact, based for example on where the system is located (there could be highway applications or remote applications or city applications, for example in a car parking of a shopping center) there could be a predetermined electrical energy schedule. It is to be noted that the schedule may be the consequence of a preliminary study taken before the installation of the vehicle charging system 100. The predetermined electrical energy schedule may set the amount of the first electrical energy 12 and the second electrical energy 14 based for example on the time of the day. Typically, during night hours the demand of electrical energy or hydrogen is lower than the demand during day hours; therefore, the schedule may set the first electrical energy 12 and the second electrical energy 14 taking into account the demand in different time of the day.

According to another possibility, the first electrical energy 12 and the second electrical energy 14 may vary according to a predetermined schedule based for example on the time of the day and/or on the day of the week and/or on the month of the year. It is to be noted that other suitable predetermined strategy may be taken into account by a person skilled in the art.

Advantageously, the vehicle charging system 100 comprises further a carbon capture unit 70 which is fluidly coupled to the gas turbine engine 10, in particular to the outlet of the expander section 3, and is configured to receive exhaust gases 15 therefrom. Typically, the carbon capture unit 70 receives exhausted gas 15 which have a non-negligible quantity of CO2 in their composition and which have to be purified before being discharged in the surrounding ambient, according for example to the recent CO2 emission regulations. With non-limiting reference to FIGS. 1 and 2, the carbon capture unit 70 performs a carbon capture on the exhausted gases 15 which enters the unit and discharge in the surrounding ambient CO2-free exhaust gases 79 (or with a negligible quantity of CO2); the CO2 captured 78 by the carbon capture unit 70 may be used for other useful applications or may be sent to a CO2 storage to be sell. Preferably, the carbon capture unit 70 is Compact Carbon Capture (3C) by Baker Hughes.

Advantageously, the vehicle charging system 100 comprises further a waste heat recovery unit 50 which is fluidly coupled to the gas turbine engine 10, in particular to the outlet of the expander section 3, and is configured to receive exhaust gases 15 therefrom. Preferably, the waste heat recovery unit 50 is configured to transfer heat from exhaust gases 15 to the electrolyzer 3, in the form of a hot water or steam flow 51.

Advantageously, the vehicle charging system 100 comprises further a heat exchanger 60 which is configured to transfer heat from at least part of the hot water or steam flow 51 from the waste heat recovery unit 50 to a demineralized water flow 61 which is then provided to the electrolyzer 30. With non-limiting reference to FIG. 2, a demineralized water flow 61 enters the heat exchanger 60 and is heated by the heat exchanger 60 which transfer heat from at least part of the hot water or steam flow 51 to the demineralized water flow 61.

Advantageously, if the carbon capture unit 70 is present, the carbon capture unit 70 is fluidly coupled to the waste heat recovery unit 50 and is configured to receive the steam flow 51; in other word, if the carbon capture unit 70 is present, flow 51 is a steam flow 51 and part of it (see the reference 53 in FIG. 2) is sent to the carbon capture unit 70 to perform carbon capture. More advantageously, if the carbon capture unit 70 is present, at least part of the steam flow 53 received is then recirculated (see the reference 77 in FIG. 2) in the waste heat recovery unit 50 by means of a pump 75. Even more advantageously, the steam flow 51 at the outlet of the heat exchanger 60, after having transfer heat to the demineralized water flow 61, is then recirculated (see the reference 76 in FIG. 2) in the waste heat recovery unit 50 by means of the pump 75.

Advantageously, the vehicle charging system comprises further a fan 71 which is configured to receive the exhaust gases 15 from the gas turbine engine 10 and to blow the exhaust gases 15 to the carbon capture unit 70. Preferably, if both the waste heat recovery unit 50 and the carbon capture unit 70 are present, the fan 71 is located downstream the waste heat recovery unit 50 and is configured to blow the exhaust gases 15 to the carbon capture unit 70, in order to overcome pressure losses across the waste heat recovery unit 50.

Advantageously, the fan 71 is mechanically coupled to a second electric motor 72 which is configured to convert electrical energy into mechanical energy to drive the fan 71. Preferably, the second electric motor 71 is electrically coupled to the power splitter 11 and is configured to receive at least part of the third electrical energy 13 therefrom.

1-17. (canceled)

18. A vehicle charging system comprising:
a gas turbine engine,
an electric generator,
wherein the electric generator is mechanically coupled to the gas turbine engine and is configured to generate an electrical energy,
a power splitter electrically coupled to the electric generator,
wherein the power splitter is configured to split the electrical energy produced only by the electric generator at least into a first electrical energy and a second electrical energy; wherein the system is configured so that the first electrical energy is used for charging electric vehicles and the second electrical energy is used for charging hydrogen vehicles.

19. The vehicle charging system of claim 18, wherein the gas turbine engine is configured to produce a constant in time electrical energy, in particular it is configured to operate always at nominal power.

20. The vehicle charging system of claim 18, wherein the power splitter is configured to operate depending on electric vehicles and hydrogen vehicles connected to the system.

21. The vehicle charging system of claim 18, wherein the power splitter is configured to operate according to a predetermined strategy.

22. The vehicle charging system of claim 18, comprising further:
an electrolyzer configured to perform electrolysis of water to generate hydrogen,
an electric vehicle charging station configured to be coupled to at least one electric vehicle,
a hydrogen vehicle charging station configured to be coupled to at least one hydrogen vehicle,
wherein the electric vehicle charging station is electrically coupled to the power splitter and configured to receive the first electrical energy,
wherein the electrolyzer is electrically coupled to the power splitter and configured to receive the second electrical energy,
wherein the hydrogen vehicle charging station is fluidly coupled to the electrolyzer and configured to receive hydrogen.

23. The vehicle charging system of claim 18, comprising further at least one auxiliary device,
wherein the power splitter is configured to split the electrical energy into a first electrical energy, a second electrical energy and a third electrical energy, wherein the third electrical energy is smaller than the first electrical energy and the second electrical energy,
wherein the at least one auxiliary device is electrically coupled to the power splitter and is configured to receive the third electrical energy.

24. The vehicle charging system according to claim 22, wherein the electric vehicle charging station comprises an electric storage unit configured to store electrical energy,
wherein the electric storage unit is electrically coupled to the power splitter and is configured to receive the first electrical energy.

25. The vehicle charging system according to claim 22, wherein the hydrogen vehicle charging station comprises a hydrogen storage unit configured to store hydrogen,
wherein the hydrogen storage unit is fluidly coupled to the electrolyzer and is configured to receive hydrogen.

26. The vehicle charging system according to claim 24, wherein the hydrogen vehicle charging station comprises further at least a compressor,
wherein the compressor is fluidly coupled to the electrolyzer and is configured to receive hydrogen,
wherein the compressor is configured to compress hydrogen produced by the electrolyzer, and to provide compressed hydrogen to the hydrogen storage unit.

26. The vehicle charging system according to claim 25, comprising further a first electric motor, wherein the compressor is mechanically coupled to the first electric motor,
wherein the first electric motor is electrically coupled to the power splitter and is configured to receive at least part of the third electrical energy.

27. The vehicle charging system according to claim 18, wherein the gas turbine engine performs combustion and produces exhaust gases, and wherein the vehicle charging system comprises further a carbon capture unit,
wherein the carbon capture unit is fluidly coupled to the gas turbine engine and is configured to receive exhaust gases.

28. The vehicle charging system according to claim 18, wherein the gas turbine engine performs combustion and produces exhaust gases, and wherein the vehicle charging system comprises further a waste heat recovery unit,
wherein the waste heat recovery unit is fluidly coupled to the gas turbine engine and is configured to receive exhaust gases,
wherein the waste heat recovery unit is preferably configured to transfer heat from exhaust gases to an electrolyzer, in the form of a hot water or steam flow.

29. The vehicle charging system according to claim 27, comprising further a heat exchanger,
wherein the heat exchanger is configured to transfer heat from at least part of the hot water or steam flow to a demineralized water flow,
wherein the demineralized water flow is preferably provided to the electrolyzer.

30. The vehicle charging system according to claim 26, comprising further a first electric motor, wherein the compressor is mechanically coupled to the first electric motor,
wherein the first electric motor is electrically coupled to the power splitter and is configured to receive at least part of the third electrical energy,
wherein the gas turbine engine performs combustion and produces exhaust gases, and wherein the vehicle charging system comprises further a carbon capture unit,
wherein the carbon capture unit is fluidly coupled to the gas turbine engine and is configured to receive exhaust gases,
wherein the carbon capture unit is fluidly coupled to the waste heat recovery unit and is configured to receive at least part of the steam flow from the waste heat recovery unit.

31. The vehicle charging system according to claim 1, comprising further a fan, wherein the fan is configured to receive exhaust gases from the gas turbine engine and blow the exhaust gases to a carbon capture unit.

32. The vehicle charging system according to claim 29, comprising further a second electric motor, wherein the second electric motor is electrically coupled to the power splitter and is configured to receive at least part of a third electrical energy from the power splitter.
